(19) United States
(12) Patent Application Publication
(10) Pub. No.: US 2004/0030996 A1
(43) Pub. Date: Feb. 12, 2004

(54) Method and system for personalisation of digital information

(76) Inventors: Egidius Petrus Maria Van Liempd, Briltil (NL); Rene Martin Bultje, Groningen (NL)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/362,622

(22) PCT Filed: Aug. 29, 2001
(86) PCT No.: PCT/EP01/09989

(30) Foreign Application Priority Data
Aug. 30, 2000 (NL) 1016056

(51) Int. Cl. G06F 15/00

(52) U.S. Cl. 715/526

(57) ABSTRACT

System for automatic selection of messages from a message source (1) to a user terminal (2). A server (3) comprises a register (5) for storing an interest vector of the terminal user. Vectorising means (7) generate a content vector for each message. Comparison means (9) compare the content vector with the interest vector and calculate their distance, while transmission means (6) transfer to the user terminal messages for which the distance between the two vectors does not exceed a threshold value. The vectorising means reduce the content vector by means of “Latent Semantic Indexing”. The user terminal (2) comprises means (12) for assigning to each message a first relevance weighting and also means (14) for measuring treatment variables from the user's treatment of the presented message and for calculating from this a second relevance weighting. Means (13) in the server update the terminal user's interest profile on the basis of the transferred first and second relevance weighting.

### BACKGROUND OF THE INVENTION

The invention relates to a method for automatic selection and presentation of digital messages for a user, as well as a system for automatic selection and presentation of digital messages from a message source to a user terminal. Such methods and systems for “personalisation” of information gathering are generally known.

Personalisation is becoming more and more important as “added value” in services. On account of the explosive growth in available information and the character of the Internet, it is becoming more and more desirable for information to be (automatically) tailored to the personal wishes and requirements of the user. Services that can offer this therefore have a competitive edge. In addition, we see the emergence of small terminals: not only are there now the ““Personal Digital Assistants” (PDAs), such as the “Palm Pilot”, that are becoming more and more powerful, but mobile telephones are also moving up in the direction of computers. These small devices are always personal and will (relative to fixed computers) always remain relatively limited in computing power, storage capacity and bandwidth. For this reason as well, the application of personalisation techniques (in order to get only the required data on the device) is needed.

The problem is: how can a user, with a stall personal computer, easily get the information that best meets the user's personal needs. A small personal computer” is understood to mean a computer smaller than a laptop, i.e. PDAs (Palm Pilot etc.), mobile telephones such as WAP-enabled telephones, etc. The information could, for example, consist of daily news items, but possibly also reports etc.

At the moment, there are already news services available on mobile telephones (for example via KPN's “@-Info” service). These are not, however, personalised. In order to cope with the limited bandwidth/storage capacity, either the messages must be kept very short, and will therefore lack the desired level of detail, or the user must indicate, via a great many “menu clicks” and waits, exactly what he wishes to see.

Although standard browsers on the Internet do offer personalised information services, this personalisation does not usually extend beyond the possibility of modifying the layout of the information items. In so far as personalisation relates to the contents, it will usually be required of the user to indicate information categories in which he is interested. This is usually either too coarse: for example, a user may indicate an interest in “sport”, but is not in fact interested in football, only in rowing, or it is very time-consuming for the user, for example the user may not by interested in rowing in general, but only in competitive rowing. It would take a long time to define the exact area of interest in each case. Moreover, the user often does not know explicitly what his exact areas of interest are.

For some news services and search engines a facility is offered by which information is selected from the text or the headers on the basis of keywords. This method requires a lot of computing power (there are thousands of different words) and can, moreover, produce all sorts of ambiguities and misses. A search on the subject of “fly”, for example, might give results relating to both insects and airline flights.

### SUMMARY OF THE INVENTION

It is an object of the present invention to provide an advanced and personalised service for searching and presenting (textual) information on small devices. To this end, the invention provides a method for automatic selection and presentation of digital messages for a user, as well as a system for automatic selection and presentation of digital messages from a message source to a user terminal. The method according to the invention provides the following steps:

a. an interest profile of the user is generated in the form of an interest vector in a K-dimensional space in which K is the number of characteristics that discriminate whether or not a document is considered relevant for the user, the user assigning a weight to each word in accordance with the importance assigned by the user to the word;

b. for each message, on the basis of words occurring in the message, a content vector is generated in an N-dimensional space in which N is the total number of relevant words over all messages, with a weight being assigned to each word occurring in the message in proportion to the number of times that the word occurs in the message relative to the number of times that the word occurs in all messages (“Term Frequency-Inverse Document Frequency”, TF-IDS);

c. the content vector is compared with the interest vector and—the cosine measure of—their (vectorial) distance is calculated (cosine measure: the cosine of the angle between two document/content/interest representation vectors);

d. messages for which the distance between the content vector and the interest vector does not exceed a given threshold value are presented to the user.

The content vector is, before being compared with the interest vector, reduced by means of “Latent Semantic Indexing”—known from, amongst other sources—U.S. Pat. No. 4,839,853 and U.S. Pat. No. 5,301,109. Application of LSI results in documents and users being represented by vectors of a few hundred elements, in contrast with the vectors of thousands of dimensions required for keywords. This reduces and speeds up the data processing and, moreover, LSI provides for a natural aggregation of documents relating to the same subject, even if they do not contain the same words. For the distance between the content vector and the interest vector, the “cosine measure” is usually calculated.

The messages are preferably sorted by relevance on the basis of the respective distances between their content vector and the interest vector. After sorting by relevance, the messages are then offered to the user.

Preferably, the user can assign to each presented message a first relevance weighting by which the user's interest profile can be adjusted. In addition, treatment variables can be measured from the user's treatment of the presented message. From the measured values of those treatment variables a second relevance weighting can then be calculated by which the user's interest profile can be adjusted automatically.

### EMBODIMENTS

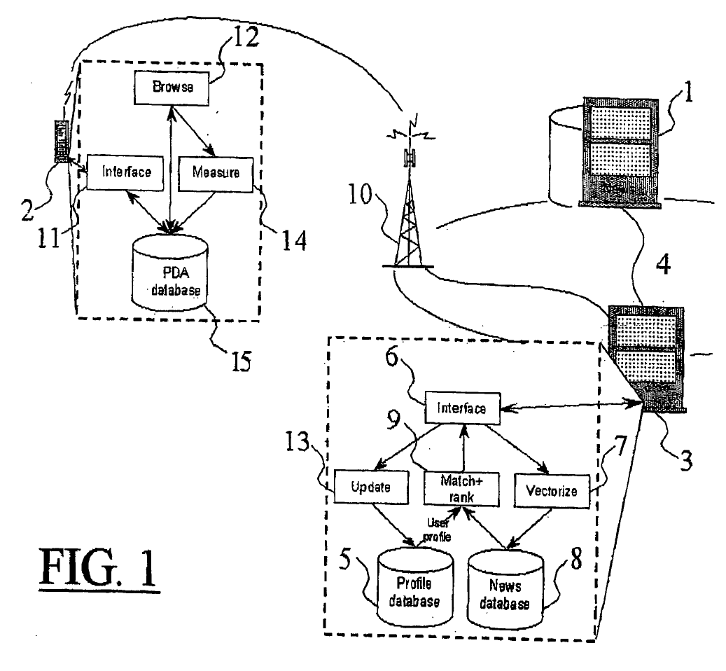

FIG. 1 shows schematically a system by which the method according to the invention can be implemented. FIG. 1 thus shows a system for automatic selection and presentation of digital messages from a message source, for example a news server 1, to a user terminal 2. The automatic selection and presentation of the digital messages is performed by a selection server 3 that receives the messages from the news server 1 via a network 4 (for example the Internet). The selection server 3 comprises a register 5 in which an interest profile of the terminal user is stored in the form of an interest vector in a K-dimensional space in which K is the number of characteristics that discriminate whether a document is or is not considered relevant for the user. The user first assigns to each word a weight in accordance with the importance assigned to the word by the user. Messages originating from news server 1 are offered in server 3 via an interface 6 to a vectorising module. A content vector is generated in this module for each message on the basis of words occurring in the message, in an N-dimensional space, in which N is the total number of relevant words over all messages. The vectorising module 7 assigns to each word occurring in the message a weight in proportion to the number of times that this word occurs in the message relative to the number of times that the word occurs in all messages. The vectorising module 7 then reduces the content vector by means of “Latent Semantic Indexing”, as a result of which the vector becomes substantially smaller. The contents of the message are then, together with the corresponding content vector, entered into a database 8. In a comparison module 9 the content vector is compared with the interest vector and the cosine measure of their distance is calculated. Via the interface 6 functioning as transmission module, messages for which the distance between the content vector and the interest vector does not exceed a given threshold value are transferred to the mobile user terminal 2 via the network 4 and a base station 10. Prior to the transfer to the mobile terminal 2, the comparison module 9 or the transmission module 6 sorts the messages with respect to relevance on the basis of the respective distances between the their content vector and the interest vector.

The user terminal 2 comprises a module 12—a “browser” including a touch screen—by which the messages received from the server 3 via an interface 11 can be selected and partly or wholly read. Furthermore, the browser can assign to each received message a (first) relevance weighting or code, which is transferred via the interface 11, the base station 10 and the network 4 to the server 3. Via interface 6 of server 3 the relevance weighting is sent on to an update module 13, in which the interest profile stored in database 5 is adjusted by the terminal user on the basis of the transferred first relevance weighting. The user terminal 2 comprises, moreover, a measuring module 14 for the measurement of treatment variables when the user deals with the presented message. These treatment variables are transferred via the interfaces 11 and 6 to the server 3, that, in an update module 13, calculates a second relevance weighting from the measured values of these treatment variables. Subsequently, the terminal user, with the aid of the update module 13, updates the interest profile stored in database 5 on the basis of the first relevance weighting

The browser module 12 thus comprises a functionality to record the relevance feedback of the user. This consists first of all of a five-point scale per message, by which the user can indicate his explicit rating for the message (the first relevance code). In addition, the measuring module 14 implicitly detects per message which actions the user performs: has he clicked on the message, has he clicked through to the summary, has he read the message completely, for how long, etc. The measuring module thus comprises a “logging” mechanism, for which the processed result is sent to the server 3 as second relevance code, in order—together with the first relevance code—to correct the user profile.

In short, the proposed system has a modular architecture, which enables all functions required for advanced personalisation to be performed, with most of the data processing not being performed on the small mobile device 2, but on the server 3. Moreover, the most computer-intensive part of the data processing can be performed in parallel with the day-to-day use. Furthermore, the proposed system is able to achieve better personalisation (than for example via keywords) by making use of Latent Semantic Indexing (LSI) for the profiles of users and documents stored in the databases 5 and 8. LSI ensures that documents and users are represented by vectors of a few hundred elements, in contrast with the vectors of thousands of dimensions required for keywords. This reduces and speeds up the data processing and, moreover, LSI provides for a natural aggregation of documents relating to the same subject, even if they do not contain the same words.

By means of a combination of explicit and implicit feedback, using the first and second relevance code respectively, the personalisation system can automatically modify and train the user's profile. Explicit feedback, i.e. an explicit evaluation by the user of an item read by him is the best source of information, but requires some effort from the user. Implicit feedback, on the other hand, consists of nothing more than the registration of the terminal user's behaviour (which items has he read, for how long, did he scroll past an item, etc.) and requires no additional effort from the user, but—with the aid of “data mining” techniques—can be used to estimate the user's evaluation. This is, however, less reliable than direct feedback. A combination of implicit and explicit feedback has the advantages of both techniques.

Incidentally, explicit feedback, input by the user, is not of course necessary for every message; implicit feedback from the system often provides sufficient information. Finally, an elaborated example will now be given of personalisation on the basis of Latent Semantic Indexing (LSI).

Personalisation refers to the matching of supply to the needs of users. This generally requires three activities to be performed. Supply and user needs must be represented in a way that makes it possible to compare them with one another, and then they must actually be compared in order to ascertain which (part of the) supply satisfies user needs and which part does not. At the same time, it is necessary for changing user needs to be followed and for the representation of these needs (the user profile) to be modified accordingly. This document sets out how Latent Semantic Indexing (LSI) can be used for describing supply—in this case news messages—and what consequences this has for the two other processes, the description of user needs and their comparison with the supply.

Documents and terms are indexed by LSI on the basis of a collection of documents. This means that the LSI representation of a particular document is dependent on the other documents in the collection. If the document is part of another collection, a different LSI representation may be created.

The starting point is formed by a collection of documents, from which formatting, capital letters, punctuation, filler words and the like are removed and in which terms are possibly reduced to their root: walks, walking and walked->walk. The collection is represented as a term document matrix A, with documents as columns and terms as rows. The cells of the matrix contain the frequency that each term (root) occurs in each of the documents. These scores in the cells can still be corrected with a local weighting of the importance of the term in the document and with an approximate weighting of the importance of the term in the whole collection of documents: for example terms that occur frequently in all documents in a collection are not very distinctive and are therefore assigned a low weighting. When applied to the sample collection of documents listed in Table 1, this results in the term document matrix A in Table 2.

TABLE 1
Sample collection of documents.

| | |
|---|---|
| c1 | Human Machine Interface for Lab ABC |
| | Computer Applications |
| c2 | A Survey of User Opinion of Computer |
| | System Response Time |
| c3 | The EPS User Interface Management System |
| c4 | System and Human System Engineering |
| | Testing of EPS |
| c5 | Relation of User-Perceived Response Time |
| | to Error Measurement |
| m1 | The Generation of Random, Binary, |
| | Unordered Trees |
| m2 | The Intersection Graph of Paths in Trees |
| m3 | Graph Minors IV: Widths of Trees and Well- |
| | Quasi-Ordering |
| m4 | Graph Minors: A Survey |

When constructing the matrix A in Table 2, only those words are taken from the documents in the example that occur at least twice in the whole collection and that, moreover, are not included in a list of filler words (“the”, “of”, etc.). In Table 1 these words are shown in italics; they form the rows in the matrix A.

TABLE 2
Term document matrix A on the basis of the example
in Table 1.

| | | documents | | | | | | | | |
|---|---|---|---|---|---|---|---|---|---|---|
| | terms | c1 | c2 | c3 | c4 | c5 | m1 | m2 | m3 | m4 |
| A = | human | 1 | 0 | 0 | 1 | 0 | 0 | 0 | 0 | 0 |
| | interface | 1 | 0 | 1 | 0 | 0 | 0 | 0 | 0 | 0 |
| | computer | 1 | 1 | 0 | 0 | 0 | 0 | 0 | 0 | 0 |
| | user | 0 | 1 | 1 | 0 | 1 | 0 | 0 | 0 | 0 |
| | system | 0 | 1 | 1 | 2 | 0 | 0 | 0 | 0 | 0 |
| | response | 0 | 1 | 0 | 0 | 1 | 0 | 0 | 0 | 0 |
| | time | 0 | 1 | 0 | 0 | 1 | 0 | 0 | 0 | 0 |
| | EPS | 0 | 0 | 1 | 1 | 0 | 0 | 0 | 0 | 0 |
| | survey | 0 | 1 | 0 | 0 | 0 | 0 | 0 | 0 | 1 |
| | trees | 0 | 0 | 0 | 0 | 0 | 1 | 1 | 1 | 0 |
| | graph | 0 | 0 | 0 | 0 | 0 | 0 | 1 | 1 | 1 |
| | minors | 0 | 0 | 0 | 0 | 0 | 0 | 0 | 1 | 1 |

The essence of LSI is formed by the matrix operation Singular Value Decomposition (SVD), that decomposes a matrix into the product of 3 other matrices:

$${A}_{( t \times d )} = {U}_{( t \times t )} \cdot {\sum }_{( t \times d )} \cdot {{V}^{T}}_{( d \times d )}$$

The dimensions of the matrices are shown below. This is made clearer in the following equation.

$$\underbrace{t {[ ]}^{d}}_{A} = \underbrace{t {[ ]}^{t}}_{U} \cdot \underbrace{t {[ \begin{matrix}{σ}_{1} & 0 & 0 \\ 0 & ⋰ & 0 \\ 0 & 0 & {σ}_{p} \\ 0 & ⋯ & 0 \\ ⋮ & ⋰ & ⋮ \\ 0 & ⋯ & 0\end{matrix} ]}^{d}}_{\sum } \cdot \underbrace{d {[ ]}^{d}}_{{V}^{T}}$$

Here p=min(t,d). The values in the matrix Σ are arranged so that

σ₁≧σ₂≧ . . . ≧σᵣ>σᵣ₊₁= . . . =σₚ=0.

Because the lower part of Σ is empty (contains only zeros) the multiplication becomes

$${A}_{( t \times d )} = {U}_{( t \times p )} \cdot {\sum }_{( p \times p )} \cdot {{V}^{T}}_{( p \times d )}$$

This shows clearly that documents are not represented by terms and vice versa, such as in matrix A (t×d), but that both terms and documents—in matrices U (t×p) and V (d×p) respectively—are represented by p independent dimensions. The singular values in the matrix Σ make clear what the ‘strength’ of each of those p dimensions is. Only r dimensions (r≦p) have a singular value greater than 0; the others are considered irrelevant. The essence of LSI resides in the fact that not all r dimensions with a positive singular value are included in the description, but that only the largest k dimensions (k<<r) are considered to be important. The weakest dimensions are assumed to represent only noise, ambiguity and variability in word choice, so that by omitting these dimensions, LSI produces not only a more efficient, but at the same time a more effective representation of words and documents. The SVD of the matrix A in the example (Table 2) produces the following matrices U, Σ and V^{T}.

| | | | | | | | | | |
|---|---|---|---|---|---|---|---|---|---|
| U = | 0.2 | — | 0.2 | — | — | — | 0.5 | — | — |
| | 2 | 0.1 | 9 | 0.4 | 0.1 | 0.3 | 2 | 0.0 | 0.4 |
| | | 1 | | 1 | 1 | 4 | | 6 | 1 |
| | 0.2 | — | 0.1 | — | 0.2 | 0.5 | — | — | — |
| | 0 | 0.0 | 4 | 0.5 | 8 | 0 | 0.0 | 0.0 | 0.1 |
| | | 7 | | 5 | | | 7 | 1 | 1 |
| | 0.2 | 0.0 | — | — | — | — | — | 0.0 | 0.4 |
| | 4 | 4 | 0.1 | 0.5 | 0.1 | 0.2 | 0.3 | 6 | 9 |
| | | | 6 | 9 | 1 | 5 | 0 | | |
| | 0.4 | 0.0 | — | 0.1 | 0.3 | 0.3 | 0.0 | 0.0 | 0.0 |
| | 0 | 6 | 0.3 | 0 | 3 | 8 | 0 | 0 | 1 |
| | | | 4 | | | | | | |
| | 0.6 | — | 0.3 | 0.3 | — | — | — | 0.0 | 0.2 |
| | 4 | 0.1 | 6 | 3 | 0.1 | 0.2 | 0.1 | 3 | 7 |
| | | 7 | | | 6 | 1 | 7 | | |
| | 0.2 | 0.1 | — | 0.0 | 0.0 | — | 0.2 | — | — |
| | 7 | 1 | 0.4 | 7 | 8 | 0.1 | 8 | 0.0 | 0.0 |
| | | | 3 | | | 7 | | 2 | 5 |
| | 0.2 | 0.1 | — | 0.0 | 0.0 | — | 0.2 | — | — |
| | 7 | 1 | 0.4 | 7 | 8 | 0.1 | 8 | 0.0 | 0.0 |
| | | | 3 | | | 7 | | 2 | 5 |
| | 0.3 | — | 0.3 | 0.1 | 0.1 | 0.2 | 0.0 | — | — |
| | 0 | 0.1 | 3 | 9 | 1 | 7 | 3 | 0.0 | 0.1 |
| | | 4 | | | | | | 2 | 7 |
| | 0.2 | 0.2 | — | — | — | 0.0 | — | — | — |
| | 1 | 7 | 0.1 | 0.0 | 0.5 | 8 | 0.4 | 0.0 | 0.5 |
| | | | 8 | 3 | 4 | | 7 | 4 | 8 |
| | 0.0 | 0.4 | 0.2 | 0.0 | 0.5 | — | — | 0.2 | — |
| | 1 | 9 | 3 | 3 | 9 | 0.3 | 0.2 | 5 | 0.2 |
| | | | | | | 9 | 9 | | 3 |
| | 0.0 | 0.6 | 0.2 | 0.0 | — | 0.1 | 0.1 | — | 0.2 |
| | 4 | 2 | 2 | 0 | 0.0 | 1 | 6 | 0.6 | 3 |
| | | | | | 7 | | | 8 | |
| | 0.0 | 0.4 | 0.1 | — | — | 0.2 | 0.3 | 0.6 | 0.1 |
| | 3 | 5 | 4 | 0.0 | 0.3 | 8 | 4 | 8 | 8 |
| | | | | 1 | 0 | | | | |
| Σ = | 3.3 | | | | | | | | |
| | 4 | | | | | | | | |
| | | 2.5 | | | | | | | |
| | | 4 | | | | | | | |
| | | | 2.3 | | | | | | |
| | | | 5 | | | | | | |
| | | | | 1.6 | | | | | |
| | | | | 4 | | | | | |
| | | | | | 1.5 | | | | |
| | | | | | 0 | | | | |
| | | | | | | 1.3 | | | |
| | | | | | | 1 | | | |
| | | | | | | | 0.8 | | |
| | | | | | | | 5 | | |
| | | | | | | | | 0.5 | |
| | | | | | | | | 6 | |
| | | | | | | | | | 0.3 |
| | | | | | | | | | 6 |
| V^{T} = | 0.2 | 0.6 | 0.4 | 0.5 | 0.2 | 0.0 | 0.0 | 0.0 | 0.0 |
| | 0 | 1 | 6 | 4 | 8 | 0 | 1 | 2 | 8 |
| | — | 0.1 | — | — | 0.1 | 0.1 | 0.4 | 0.6 | 0.5 |
| | 0.0 | 7 | 0.1 | 0.2 | 1 | 9 | 4 | 2 | 3 |
| | 6 | | 3 | 3 | | | | | |
| | 0.1 | — | 0.2 | 0.5 | — | 0.1 | 0.1 | 0.2 | 0.0 |
| | 1 | 0.5 | 1 | 7 | 0.5 | 0 | 9 | 5 | 8 |
| | | 0 | | | 1 | | | | |
| | — | — | 0.0 | 0.2 | 0.1 | 0.0 | 0.0 | 0.0 | — |
| | 0.9 | 0.0 | 4 | 7 | 5 | 2 | 2 | 1 | 0.0 |
| | 5 | 3 | | | | | | | 3 |
| | 0.0 | — | 0.3 | — | 0.3 | 0.3 | 0.3 | 0.1 | — |
| | 5 | 0.2 | 8 | 0.2 | 3 | 9 | 5 | 5 | 0.6 |
| | | 1 | | 1 | | | | | 0 |
| | — | — | 0.7 | — | 0.0 | — | — | 0.0 | 0.3 |
| | 0.0 | 0.2 | 2 | 0.3 | 3 | 0.3 | 0.2 | 0 | 6 |
| | 8 | 6 | | 7 | | 0 | 1 | | |
| | 0.1 | — | — | 0.2 | 0.6 | — | — | 0.2 | 0.0 |
| | 8 | 0.4 | 0.2 | 6 | 7 | 0.3 | 0.1 | 5 | 4 |
| | | 3 | 4 | | | 4 | 5 | | |
| | — | 0.0 | 0.0 | — | — | 0.4 | — | 0.4 | — |
| | 0.0 | 5 | 1 | 0.0 | 0.0 | 5 | 0.7 | 5 | 0.0 |
| | 1 | | | 2 | 6 | | 6 | | 7 |
| | — | 0.2 | 0.0 | — | — | — | 0.0 | 0.5 | — |
| | 0.0 | 4 | 2 | 0.0 | 0.2 | 0.6 | 2 | 2 | 0.4 |
| | 6 | | | 8 | 6 | 2 | | | 5 |

The singular values in matrix Σ are shown in diagram 1 in the form of a graph.

[image]

The statement in the framework of LSI that, for example, only the 2 main singular values are of importance, rather than all 9 singular values, means that all terms and documents (in matrices U and V respectively) can be described in terms of just the first 2 columns. This can be effectively visualised in two dimensions, i.e. on the flat page, which has been done in diagram 2.

[image]

It can be seen that the two groups of documents that can be distinguished in Table 1, really can be separated from each other by applying LSI: the m-documents are concentrated along the ‘vertical’ dimension, and the c-documents along the horizontal dimension.

If it is known that a user found document m4 interesting, it can be predicted in this way that he will also find documents m1, m2 and m3 interesting, because these documents—in terms of the words used in it—exhibit a strong resemblance to the interesting document m4. In geometric terms, the angle between documents m4 and the other 3 m-documents is small, and so the cosine is large (equal to 1 for an angle of 0°, 0 for an angle of 90°, and −1 for an angle of 180°). The fact that a user finds a document interesting is represented by the profile of that user, who—just like the terms and documents—is also a vector in k-dimensional LSI space, being modified (‘shifted’) in the direction of the evaluated document. In the same way, a negative evaluation shifts the profile vector away from (the negatively evaluated) document vector: an uninteresting document leads to an evaluated document vector lying in the opposite direction from the original document vector, so that the shifting of the profile vector in the direction of the evaluated document vector leads to the profile vector moving further from the original document vector. This leads to the situation that new documents that are represented by vectors resembling the original document vector will be predicted to be less interesting, which is exactly the intention.

1. Method for automatic selection and presentation of digital messages for a user, CHARACTERISED BY the following steps:
an interest profile of the user is generated in the form of an interest vector in a K-dimensional space in which K is the number of characteristics that discriminate whether a document is or is not considered relevant for the user, wherein a weight is assigned to each word by the user in accordance with the importance assigned by the user to that word;
for each message, on the basis of words occurring in the message, a content vector is generated in an N-dimensional space in which N is the total number of relevant words over all messages, with a weight being assigned to each word occurring in the message in proportion to the number of times that the word occurs in the message relative to the number of times that the word occurs in all messages;
the content vector is compared with the interest vector and their distance is calculated;
messages for which the distance between the content vector and the interest vector does not exceed a given threshold value are presented to the user.

2. Method according to claim 1, CHARACTERISED IN THAT the content vector, before being compared with the interest vector, is reduced by means of “Latent Semantic Indexing”.

3. Method according to claim 1, CHARACTERISED IN THAT the “cosine measure” of the distance between the content vector and the interest vector is calculated.

4. Method according to claim 1, CHARACTERISED IN THAT the messages are sorted by relevance on the basis of the respective distances between their content vector and the interest vector, and that the messages sorted by relevance are offered to the user.

5. Method according to claim 1, CHARACTERISED IN THAT the user can assign to each presented message a first relevance weighting by which the user's interest profile is adjusted.

6. Method according to claim 1, CHARACTERISED IN THAT treatment variables are measured from the user's treatment of the presented message and that from the measured values of these treatment variables a second relevance weighting is calculated by which the user's interest profile is adjusted.

7. System for automatic selection and presentation of digital messages from a message source (1) to a user terminal (2), CHARACTERISED BY a server (3), comprising a register (5) for storing an interest profile of the terminal user in the form of an interest vector in a K-dimensional space in which K is the number of characteristics that discriminate whether a document is or is not considered relevant for the user, the user assigning a weight to each word in accordance with the importance assigned by the user to that word;
vectorising means (7) for generating a content vector for each message on the basis of words occurring in the message, in an N-dimensional space in which N is the total number of relevant words over all messages, wherein said means assign to each word occurring in the message a weight in proportion to the number of times that the word occurs in the message relative to the number of times that the word occurs in all messages;
comparison means (9) for comparing the content vector with the interest vector and calculating their distance;
transmission means (6) for the transfer to the user terminal of messages for which the distance between the content vector and the interest vector does not exceed a given threshold value.

8. System according to claim 1, CHARACTERISED IN THAT the vectorising means reduce the content vector by means of “Latent Semantic Indexing”.

9. System according to claim 1, CHARACTERISED IN THAT the comparison means calculate the “cosine measure” of the distance between the content vector and the interest vector.

10. System according to claim 1, CHARACTERISED IN THAT the comparison means and the transmission means transfer the messages, sorted by relevance on the basis of the respective distances between their content vector and the interest vector, to the user terminal.

11. System according to claim 1, CHARACTERISED IN THAT the user terminal (2) comprises means (12) for assigning to each transferred message a first relevance weighting and for transferring this to the server (3), as well as means (13) in the server for adjusting the terminal user's interest profile on the basis of the transferred first relevance weighting.

12. System according to claim 1, CHARACTERISED IN THAT the user terminal (2) comprises means (14) for measuring treatment variables from the user's treatment of the presented message and for calculating from the measured values of these treatment variables a second relevance weighting and transferring this to the server (3), as well as means (13) in the server for adjusting the terminal user's interest profile on the basis of the transferred second relevance weighting.
